(19) United States
(12) Patent Application Publication
(10) Pub. No.: US 2019/0026921 A1
(43) Pub. Date: Jan. 24, 2019

(54) CALCULATING DEVICE AND CALCULATING DEVICE CONTROL METHOD

(71) Applicant: SHARP KABUSHIKI KAISHA, Sakai City, Osaka (JP)

(72) Inventors: DAISUKE MURAYAMA, Sakai City (JP); KEI TOKUI, Sakai City (JP)

(73) Assignee: SHARP KABUSHIKI KAISHA, Sakai City, Osaka (JP)

(21) Appl. No.: 15/757,647

(22) PCT Filed: Aug. 15, 2016
(86) PCT No.: PCT/JP2016/073831

§ 371 Date: Mar. 5, 2018

(30) Foreign Application Priority Data
Sep. 9, 2015 (JP) 2015-177719

(51) Int. Cl. G06T 7/73; G01C 3/08; G01B 11/00; G06T 7/00

(52) U.S. Cl. CPC G06T 7/74; G01C 3/085; G06T 2207/10028; G06T 7/97; G06T 2200/04; G01B 11/002

(57) ABSTRACT

A measuring device (1) includes an analyzing unit (201) that determines whether there is an occlusion region around a measuring point candidate position configured by a user and a measuring point configuring unit (203) that, in a case that it is determined that there is an occlusion region, uses an image other than an initial reference image as a reference image and configures a measuring point on the reference image.

### TECHNICAL FIELD

One aspect of the present invention relates to a calculating device that calculates a three-dimensional position of a measuring point configured on a subject by using multiple images capturing a common subject, or the like.

### BACKGROUND ART

There is a related art for configuring a measuring point on images captured by multiple imaging devices (such as stereo cameras) disposed to be able to capture the same subject from different positions and for measuring a distance from an imaging device to a measuring point or a length between two measuring points. PTL 1 also discloses a technology for specifying two points of a measurement start position and a measurement end position on an image captured by an image capturing device and for calculating a length between the two points from a three-dimensional positional relationship between the two points.

In these technologies, a desired position on an image is specified as a measuring point to perform measurement while the image is displayed on a display device such as a liquid crystal display and a measurer checks the displayed image. Therefore, the measurer can perform measurement while visually checking a measuring position and a measuring result, and can thus obtain an advantage of being able to perform simple and easy measurement.

The measuring technologies described above calculate a parallax value of each of measuring points by using a stereo method and acquire three-dimensional positional information about each of the measuring points. In the stereo method, first, a focused point on an image captured by an imaging device being a reference for multiple imaging devices is determined, and a corresponding point corresponding to the focused point is obtained from images of imaging devices other than the reference imaging device. Next, the amount of displacement (corresponding to a parallax value) between a pixel position of the focused point and a pixel position of the corresponding point is calculated. A distance from an imaging device to the subject captured in the position of the focused point is calculated from information such as the calculated parallax value, a focal distance of an imaging device, and a base line length between the imaging devices.

### CITATION LIST

### Patent Literature

PTL 1: JP 2011-232330 A (published Nov. 17, 2011)

### SUMMARY OF INVENTION

### Technical Problem

On an image captured by multiple imaging devices disposed to be displaced from each other like stereo cameras, there is a region (referred to as an occlusion region) that can be captured from a position of one of the imaging devices but cannot be captured from a position of the other imaging device. For example, a background region covered by a subject in a foreground, a side region of a subject that cannot be captured from a position of one of imaging devices, or the like is an occlusion region.

A correct corresponding point in processing of the stereo method described above cannot be found because a subject in the occlusion region is not captured on one of images. Thus, a correct parallax value cannot be calculated, and appropriate measuring cannot be performed either. As a method for handling this, a method for estimating a parallax value of a point in an occlusion region, based on information about a region around the occlusion region that can be measured is conceivable. However, information obtained by this method is only an estimated value and thus has a low degree of reliability. A problem also arises that the amount of computing processing increases due to estimating processing.

No consideration is given to the occlusion region in the method disclosed in PTL 1. Thus, in a case that a measurer selects a position in the occlusion region as a measuring start position or a measuring end position, a measuring result cannot be obtained, or only an incorrect measuring result or a measuring result having a low degree of reliability can be obtained.

To solve the above-mentioned problems, a method for previously estimating all occlusion regions in an image and avoiding configuration of a measuring point in an occlusion region is conceivable. However, this method needs processing of previously calculating an occlusion region from the whole image, which results in a great amount of computing processing. In addition, a method for preventing a measurer himself/herself from deliberately specifying a measuring point in an occlusion region is also conceivable, but this method increases a burden on the measurer.

One aspect of the present invention has been made in view of the above-mentioned points, and an object thereof is to provide a calculating device capable of preventing a decrease in calculating accuracy due to configuration of a measuring point in or around an occlusion region without excessively increasing the amount of computing processing.

### Solution to Problem

To solve the above-mentioned problems, a calculating device according to one aspect of the present invention is a calculating device configured to calculate, by using multiple images capturing a subject that is a common subject, a three-dimensional position of a measuring point configured on the subject. The calculating device includes: an analyzing unit configured to analyze the multiple images and to determine whether there is an occlusion region in at least any of a measuring point candidate position configured by a user of the calculating device on an initial reference image as a candidate for a configured position of the measuring point, the initial reference image being one of the multiple images, and a position in a prescribed range from the measuring point candidate position; an image selecting unit configured to select an image of the multiple images other than the initial reference image as a reference image in a case that the analyzing unit determines that there is an occlusion region; and a measuring point configuring unit configured to configure the measuring point on the reference image.

To solve the above-mentioned problems, a method for controlling a calculating device according to one aspect of the present invention is a method for controlling a calculating device configured to calculate, by using multiple images capturing a subject that is a common subject, a three-dimensional position of a measuring point configured on the subject. The method includes the steps of: analyzing the multiple images and determining whether there is an occlusion region in at least any of a measuring point candidate position configured by a user of the calculating device on an initial reference image as a candidate for a configured position of the measuring point, the initial reference image being one of the multiple images and a position in a prescribed range from the measuring point candidate position; selecting an image of the multiple images other than the initial reference image as a reference image in a case that it is determined that there is an occlusion region in the step of analyzing the multiple images; and configuring the measuring point on the reference image.

### Advantageous Effects of Invention

According to each of the aspects of the present invention, an effect of preventing a decrease in calculating accuracy due to configuration of a measuring point in or around an occlusion region without excessively increasing the amount of computing processing is achieved.

### BRIEF DESCRIPTION OF DRAWINGS

FIG. 1 is a block diagram illustrating a constitution of a measuring device according to a first embodiment of the present invention.

FIG. 2 is a flowchart illustrating an example of processing performed by the measuring device according to the first embodiment of the present invention.

FIG. 3 is a diagram illustrating an example of a first image and a second image input to a measuring device 1.

FIG. 4 is a diagram illustrating an example of configuring a measuring point candidate position.

FIG. 5 is a diagram illustrating an example of configuring a measuring point position.

FIG. 6 is a diagram illustrating an example of configuring a measuring point candidate position and a measuring point position.

FIG. 7 is a diagram illustrating an example of a measuring result.

FIG. 8 is a block diagram illustrating a constitution of a measuring device according to a second embodiment of the present invention.

FIG. 9 is a flowchart illustrating an example of processing performed by the measuring device according to the second embodiment of the present invention.

FIG. 10 is a block diagram illustrating a constitution of a measuring device according to a third embodiment of the present invention.

FIG. 11 is a flowchart illustrating an example of processing performed by the measuring device according to the third embodiment of the present invention.

### DESCRIPTION OF EMBODIMENTS

Embodiments of the present invention will be described below in detail with reference to the drawings. It should be noted that each constitution described in the present embodiments is not intended to exclusively limit the scope of the embodiments of this invention thereto as long as there is no restrictive description in particular, and is merely an example for description. Each of the drawings is used for description and may be different from an actual state.

### First Embodiment

Embodiments of the present invention will be described below in detail.

### Measuring Device 1

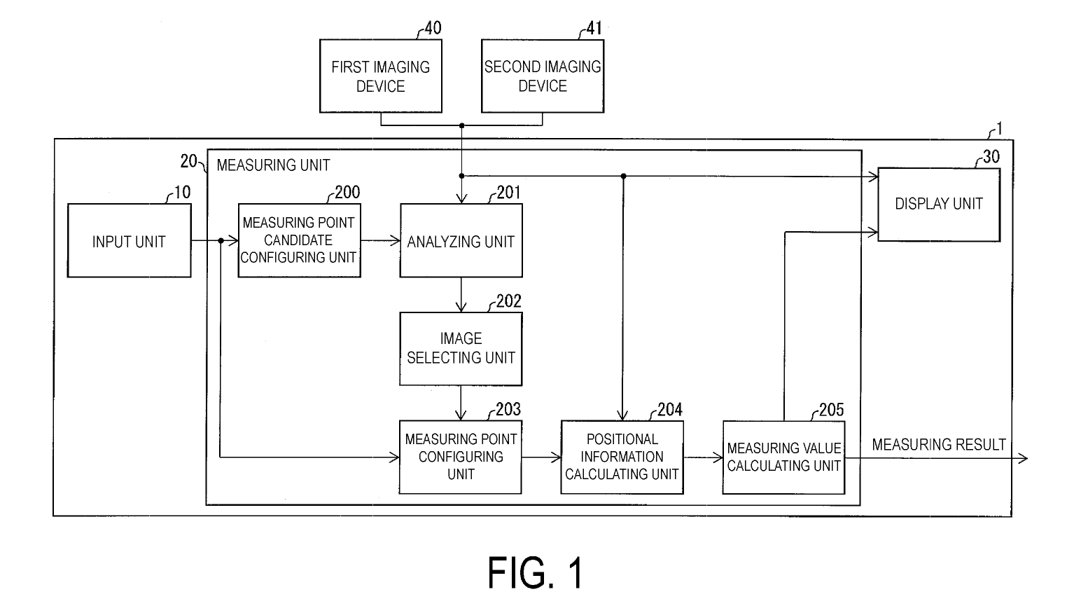

FIG. 1 is a block diagram illustrating a constitution of a measuring device (calculating device) 1 according to a first embodiment of the present invention. As illustrated in FIG. 1, the measuring device 1 according to the present embodiment includes an input unit 10, a measuring unit 20, and a display unit 30.

The input unit 10 accepts an input operation of a measurer (user of the calculating device 1) and outputs information indicating contents of the input operation to the measuring unit 20. Examples of the input unit 10 include an input device such as a mouse and a keyboard.

On the basis of the information output from the input unit 10 and a first image and a second image (multiple images capturing a common subject), the measuring unit 20 performs various kinds of processing of generating three-dimensional positional information indicating a three-dimensional position of a measuring point configured on the images.

As illustrated in FIG. 1, the measuring unit 20 includes a measuring point candidate configuring unit 200, an analyzing unit 201, an image selecting unit 202, a measuring point configuring unit 203, a positional information calculating unit 204, and a measuring value calculating unit 205.

The measuring point candidate configuring unit 200 configures a measuring point candidate position on an initial reference image according to contents of an input operation to the input unit 10 by a measurer. Note that the initial reference image is one image selected among multiple images capturing a common subject, and the initial reference image in this example is either the first image or the second image.

The analyzing unit 201 analyzes a subject in the measuring point candidate position and determines whether there is an occlusion region in at least any of the measuring point candidate position and a position within a prescribed range from the measuring point candidate position. Specifically, the analyzing unit 201 analyzes whether an occlusion region is included in at least a part of a range of the prescribed number of pixels with the measuring point candidate position as a center.

The image selecting unit 202 selects one image of the first image and the second image as a reference image on which a measuring point is configured, based on the determination result of the analyzing unit 201. Specifically, in a case that the determination result indicates that the occlusion region is not included, the image selecting unit 202 uses an image on which the measuring point candidate position is configured, namely, the initial reference image as the reference image. On the other hand, in a case that the determination result indicates that the occlusion region is included, the image selecting unit 202 uses an image other than the initial reference image among images capturing the subject common to the subject of the initial reference image as the reference image.

The measuring point configuring unit 203 configures a measuring point on the reference image selected by the image selecting unit 202. A position of the measuring point is determined by the input operation to the input unit 10 by the measurer.

The positional information calculating unit 204 calculates three-dimensional positional information about the measuring point configured by the measuring point configuring unit 203. Note that a method for calculating the three-dimensional positional information will be described later.

The measuring value calculating unit 205 performs prescribed measuring processing regarding a three-dimensional position of the measuring point by using the three-dimensional positional information about the measuring point calculated by the positional information calculating unit 204. The measuring value calculating unit 205 measures a distance from the imaging device capturing the reference image to a position corresponding to the measuring point in the captured subject, which will be described later in detail. In a case that the measuring point configuring unit 203 configures multiple measuring points and the positional information calculating unit 204 calculates three-dimensional positional information about each of the multiple measuring points, the measuring value calculating unit 205 calculates a length connecting the measuring points and an area of a region surrounded by the measuring points by using the three-dimensional positional information about the measuring points.

The display unit 30 performs display according to an output of the measuring unit 20. Examples of the display unit 30 include a display device including a liquid crystal element, an organic Electro Luminescence (EL), or the like as a pixel. Note that the present embodiment describes an example of incorporating the display unit 30 into the measuring device 1, but the display unit 30 may be provided outside the measuring device 1. For example, a television display, a Personal Computer (PC) monitor, or the like may be used as the display unit 30, and a display of a portable terminal such as a smart phone and a tablet terminal may be used as the display unit 30 to display an output of the measuring unit 20. The input unit 10 and the display unit 30 may be integrally formed and mounted as a touch panel (such as a resistive film touch panel and a capacitive touch panel).

FIG. 1 also illustrates a first imaging device 40 and a second imaging device 41 (multiple imaging devices). The first imaging device 40 and the second imaging device 41 capture a common subject. An image captured by the first imaging device 40 is the first image, and an image captured by the second imaging device 41 is the second image. These images are input to the measuring device 1. The first imaging device 40 and the second imaging device 41 may be, for example, a device that includes an optical system such as a lens module, an image sensor such as a Charge Coupled Device (CCD) and a Complementary Metal Oxide Semiconductor (CMOS), an analog signal processing unit, and an Analog/Digital (A/D) converting unit, and that outputs a signal from the image sensor as an image.

The first image and the second image are captured so as to include at least a part of a common region (common subject) from different positions by the first imaging device 40 and the second imaging device 41, respectively. More specifically, it is assumed that the first image and the second image are images respectively captured by the first imaging device 40 and the second imaging device 41 (stereo camera) disposed on the same horizontal plane such that their optical axes are substantially parallel to each other. It is described on the assumption that the first imaging device 40 and the second imaging device 41 on the same horizontal plane are respectively disposed on the left side and the right side with respect to a subject. The image captured by the first imaging device 40 is referred to as a left viewpoint image, and the image captured by the second imaging device 41 is referred to as a right viewpoint image. Moreover, each of the images is provided with information about the imaging device capturing the image. Specifically, the captured image is provided with information including a focal distance of the imaging device (the first imaging device 40, the second imaging device 41), a camera parameter such as a pixel pitch of a sensor, and a base line length between the imaging devices. Note that the information may be managed independently of image data.

### Measuring Method

A parallax value of the first image and the second image captured as described above can be calculated by a stereo method. Calculation of a distance by the stereo method is described herein before a measuring method according to the present embodiment is described.

In the stereo method, first, two imaging devices aligned such that optical axes are substantially parallel to each other capture at least a part of a common region. Next, a correspondence of pixels between the two obtained images is obtained to calculate a parallax value, and a distance from an imaging device to a subject is calculated based on the parallax value. For example, stereo matching is applicable as a method for obtaining the correspondence of pixels between two images. In the stereo matching, one of two images is configured as a reference image, and the other image is configured as a comparison image. A corresponding pixel to an arbitrary focused pixel on the reference image is searched by scanning the comparison image. A scanning direction for searching for the corresponding pixel is the same as a direction connecting positions in which two imaging devices are disposed. For example, a scanning axis in a case that two imaging devices are disposed on the same horizontal axis is parallel to the horizontal axis, and a scanning axis in a case that two imaging devices are disposed on the same vertical axis is parallel to the vertical axis.

Examples of a method for searching for a corresponding pixel on a comparison image include a method for searching for a corresponding pixel on a block-to-block basis with a focused pixel as a center. The method calculates Sum of Absolute Differences (SAD) that takes on a total sum of difference absolute values between a pixel value in a block including the focused pixel on a reference image and a corresponding pixel value in a block on a comparison image, and determines a block having the minimum value of the SAD to search for a corresponding pixel. Note that a calculating technique such as Sum of Squared Differences (SSD), a graph cut, and Dynamic Programming (DP) matching can also be used other than the calculating technique by the SAD. A parallax value is a difference between a position of the focused pixel on a reference image and a position of a corresponding pixel on a comparison image. Thus, a parallax value in each pixel of the reference image can be calculated by iterating the stereo matching while changing a position of the focused pixel and by obtaining the corresponding pixel to the focused pixel. However, a parallax value can be calculated by the stereo matching for only pixels included in the common region (region where the same position of the same subject is captured) of the first image and the second image.

A parallax value is expressed in Equation (1) below.

$$D = \frac{f \times B}{p \times Z} \qquad [ Equation 1 ]$$

Here, D is a parallax value (pixel unit). Z is a distance from an imaging device to a subject. f is a focal distance of the imaging device. B is a base line length between two imaging devices. p is a pixel pitch of an image sensor included in the imaging device. As seen from Equation (1), a smaller value of the distance Z increases the parallax value D, and a greater value of the distance Z reduces the parallax value D. Note that the parallax value D and the distance Z from the base line to the subject can be converted to each other by Equation (1). More strictly speaking, the Z is a distance from an optical center of a lens of the imaging device capturing the reference image to the subject.

### Flow of Processing

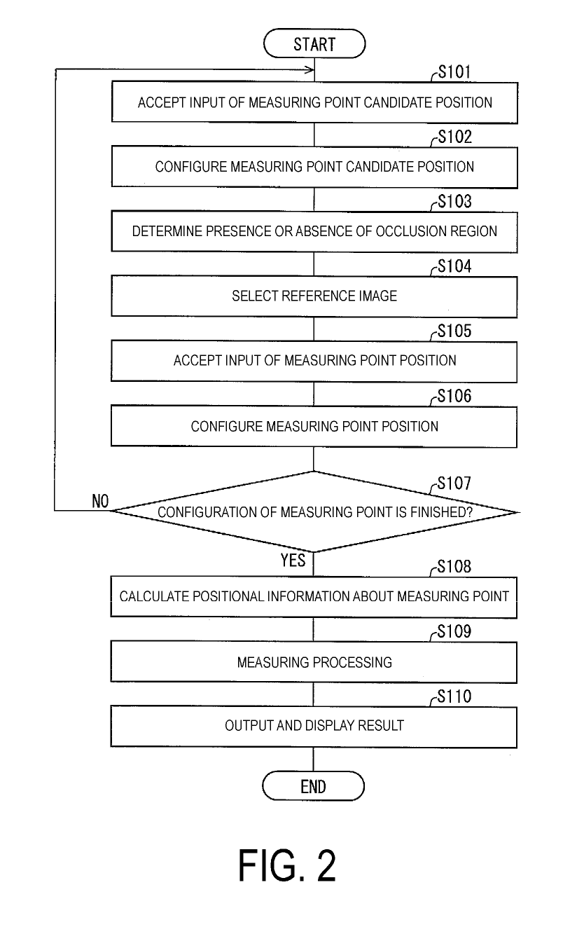

With reference to FIGS. 2 to 7, a measuring method (a method for controlling a calculating device) by using the measuring device 1 according to the present embodiment will be described below. FIG. 2 is a flowchart illustrating an example of processing performed by the measuring device 1. Note that FIG. 2 illustrates processing from a state in which multiple images (first image and second image) capturing a common subject have already been input to the measuring device 1, it has already been determined that which image is used as the initial reference image, and the initial reference image is displayed on the display unit 30. The initial reference image can be either the first image or the second image, but an example of using the first image as the initial reference image is described in the present embodiment. The present embodiment also describes an example of calculating a value of a measuring result based on a camera coordinate system of the first imaging device 40 capturing the initial reference image.

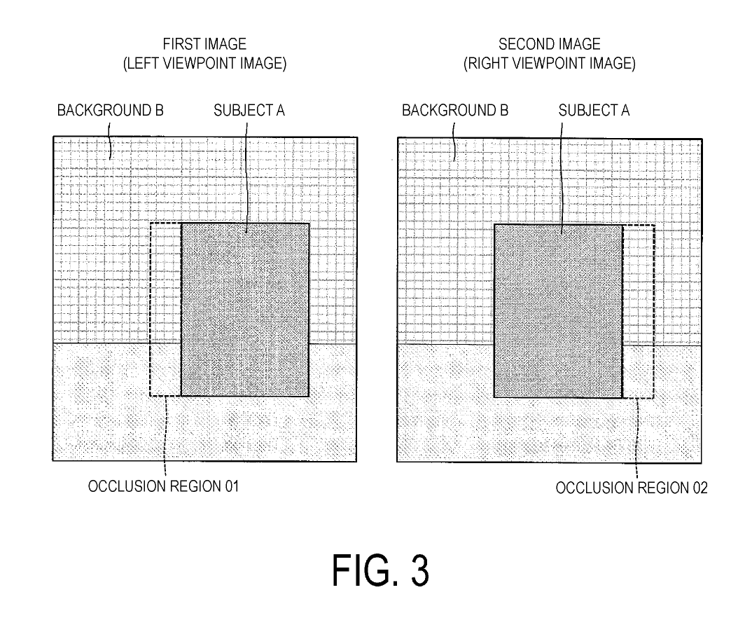

Images as illustrated in FIG. 3 can be used as two images input to the measuring device 1. FIG. 3 is a diagram illustrating an example of the first image and the second image captured by the first imaging device 40 and the second imaging device 41, respectively. The first image and the second image in FIG. 3 are images capturing a subject A disposed in front of a background B. An occlusion region O1 that is not captured in the second image is illustrated in the first image. An occlusion region O2 that is not captured in the first image is illustrated in the second image.

The measuring device 1 displays the first image (left viewpoint image) of the input images as the initial reference image on the display unit 30. A measurer then inputs a measuring point candidate position on the first image by the input unit 10 while looking at the first image. A method for accepting an input of the measuring point candidate position is preferably a method allowing for a measurer to specify a desired position on the initial reference image displayed on the display unit 30 as the measuring point candidate position by an intuitive operation. Examples of the method include a method for moving a cursor by using a mouse and clicking a desired position on a display image, a method for touching a desired position on a display image with a finger by using a touch panel, and the like. When accepting the input of the measuring point candidate position in such a manner, the input unit 10 outputs information indicating the accepted position (such as a coordinate value) to the measuring point candidate configuring unit 200. Note that the information indicating the measuring point candidate position may be input from an input device (external device) different from the input unit 10 to the measuring unit 20 (more specifically, the measuring point candidate configuring unit 200).

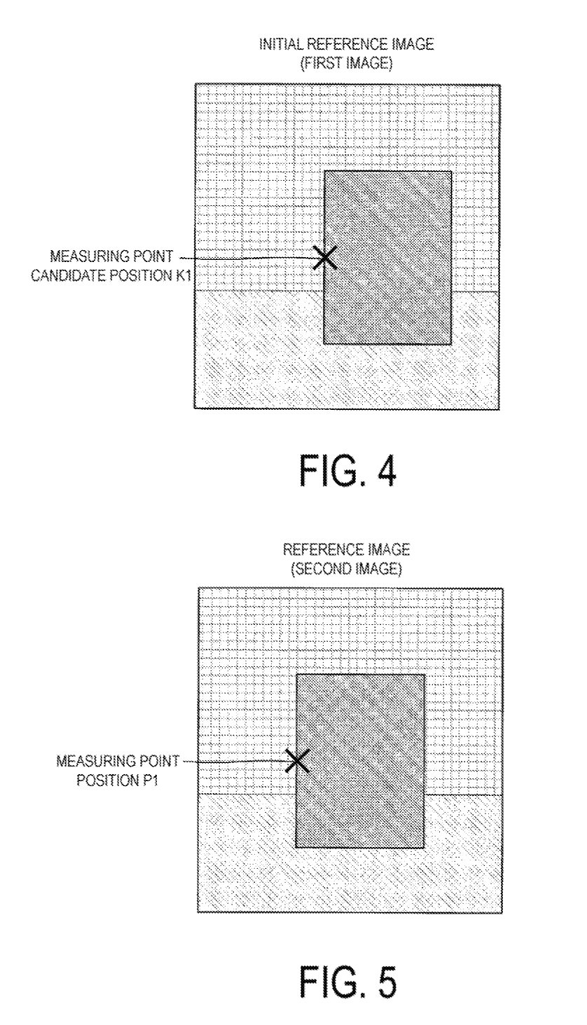

The measuring point candidate configuring unit 200 accepts the information indicating the measuring point candidate position from the input unit 10 (S101). The measuring point candidate configuring unit 200 configures the position indicated by the accepted information as the measuring point candidate position on the initial reference image (S102). FIG. 4 is a diagram illustrating an example of the measuring point candidate position configured on the initial reference image. FIG. 4 illustrates that a measuring point candidate position K1 is configured in a left edge position of the subject A. The measuring point candidate position K1 is a position close to the occlusion region O1 illustrated in FIG. 3.

Next, the analyzing unit 201 analyzes the first image and the second image and determines a state of the measuring point candidate position. More specifically, the analyzing unit 201 analyzes the first image and the second image and determines whether the occlusion region is included in a range of the prescribed number of pixels around the measuring point candidate position (S103, analyzing step).

Specifically, the analyzing unit 201 calculates a degree of similarity between the first image and the second image in the measuring point candidate position and in the range of the prescribed number of pixels around the measuring point candidate position, and in a case that the degree of similarity is low, the analyzing unit 201 determines that the range includes the occlusion region. The prescribed number of pixels is the number of pixels corresponding to an arbitrary value that can be configured in advance. The measurer may configure the number of pixels according to the purpose. The degree of similarity can be calculated by using a known technique such as the SAD described above. In a case of using the SAD, the lower degree of similarity increases a value of the SAD. Thus, a threshold value is configured for the value of the SAD in advance, and in a case that a calculated value of the SAD is greater than the threshold value in the range of the prescribed number of pixels around the measuring point candidate position on the first image and the second image, the analyzing unit 201 determines that the degree of similarity between the first image and the second image in the region is low. For example, in the example of FIG. 4, the occlusion region O1 is located on the left side of the measuring point candidate position K1, so that the range of the prescribed number of pixels around the measuring point candidate position includes the occlusion region O1. Thus, a calculated value of the SAD increases, and the analyzing unit 201 determines that the degree of similarity between the first image and the second image in the range is low (that the occlusion region is included).

In a case that the analyzing unit 201 determines that there is the occlusion region in S103, the image selecting unit 202 selects the second image, which is not the initial reference image, to use as the reference image. On the other hand, in a case that the analyzing unit 201 determines that there is no occlusion region in S103, the image selecting unit 202 uses the initial reference image as the reference image without change (S104, image selecting step). The display unit 30 displays the image selected by the image selecting unit 202 in S104.

Next, the measurer inputs a measuring point position on the reference image displayed on the display unit 30 similarly to the input of the measuring point candidate position described above, and the measuring point configuring unit 203 accepts information indicating the position of the measuring point candidate input by the measurer (S105). The measuring point configuring unit 203 configures the position on the reference image indicated by the accepted information as a measuring point position. In other words, the measuring point configuring unit 203 configures the measuring point on the reference image (S106, measuring point setting step).

FIG. 5 is a diagram illustrating an example of the measuring point position configured on the reference image. In the example of FIG. 5, a measuring point position P1 is configured in a left edge position of the subject A similarly to FIG. 4, but the occlusion region is not located around the measuring point position P1 because the second image is used as the reference image (see FIG. 3).

In this way, the measuring device 1 allows the measurer to avoid configuration of the measuring point on the first image with the occlusion region around a subject. The measurer configures the measuring point on the second image in which the occlusion region is not captured, and thus a decrease in measuring accuracy due to configuration of the measuring point in the occlusion region can be prevented. In a case that the occlusion region is included in blocks configured on the reference image in the stereo matching, a subject that is not present on the comparison image is searched, so that accuracy of parallax calculation significantly decreases. Particularly in a case that a position where most of the blocks are the occlusion region is configured as a measuring point, it can be said that it is impossible to calculate a correct parallax value. However, the measuring device 1 described above always searches for a subject captured in the comparison image by the stereo matching without configuring the measuring point in the occlusion region, so that accuracy of parallax calculation is high. Therefore, the measuring device 1 does not configure a position having low accuracy of parallax calculation as a measuring point, and thus a decrease in measuring accuracy can be prevented.

Note that in a case that the reference image and the initial reference image are the same image (in a case that it is determined that there is no occlusion region in S103), the processing of S105 may be omitted, and in S106, the measuring point may be configured in the measuring point candidate position input in S101. Accordingly, the number of specification performed by the measurer can be reduced.

Next, the measuring point configuring unit 203 checks whether configuration of all measuring points is finished (S107). In a case where the measuring point configuring unit 203 determines that configuration of all measuring points is not finished (NO in S107), processing returns to S101, and a next measuring point is configured in the processing of S101 to S106. Note that an input of the measuring point candidate position to the initial reference image (the first image in this example) is accepted in S101 regardless of which image is configured as the reference image in S104.

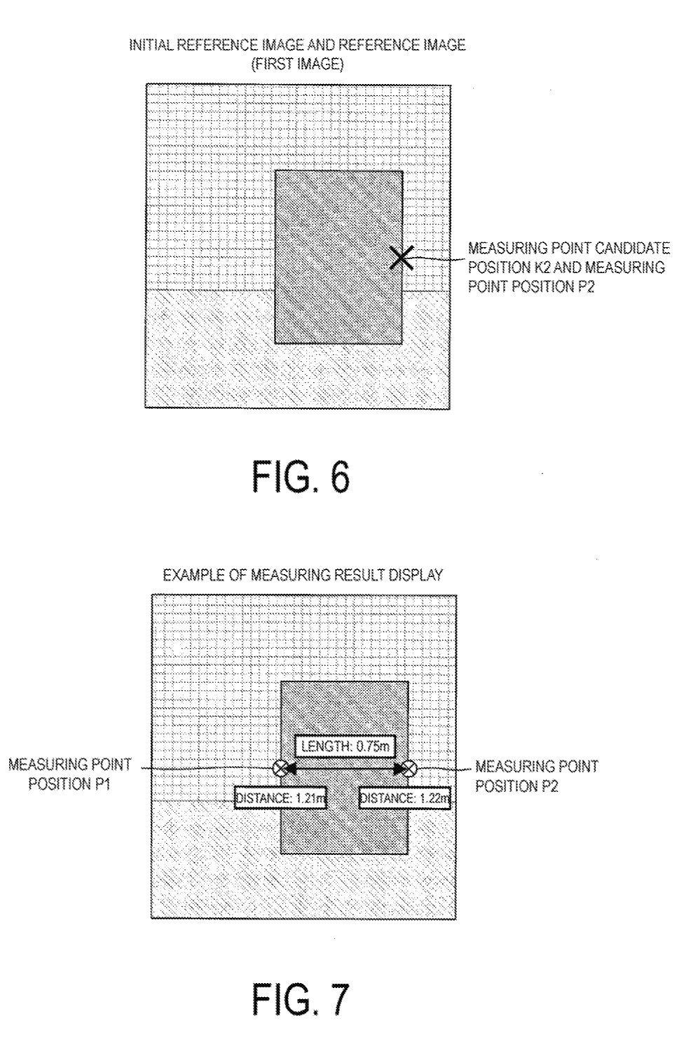

FIG. 6 is a diagram illustrating the reference image (initial reference image) on which a second measuring point is configured in a series of steps of S101 to 106 after processing returns to S101 subsequent to S107. FIG. 6 illustrates a measuring point candidate position K2 and a measuring point position P2 in the same position. In other words, FIG. 6 illustrates an example of accepting an input of the measuring point candidate position K2 in a right edge position of the subject A in the initial reference image (first image) in S101. As illustrated in FIG. 3, there is no occlusion region around the right edge position of the subject A in the first image. Thus, the determination is NO in S103, the first image being the initial reference image is selected as the reference image in S104, and the measuring point candidate position K2 is configured as the measuring point position P2 in S106.

Measuring points are successively configured in such a manner, and in a case that the measuring point configuring unit 203 determines that configuration of all measuring points is finished in S107 (YES in S107), processing proceeds to S108. In other words, until configuration of all measuring points is finished, a series of steps from S101 to 107 is iteratively performed. Note that a method for checking whether configuration of measuring points is finished may be a method capable of determining whether configuration of desired measuring points is finished by a measurer and may not be particularly limited. For example, a message may be displayed on the display unit 30 and checked by a measurer, or the number of measuring points may be configured in advance and it may be determined that configuration of all the measuring points is finished in a case that the number of configured measuring points reaches the number configured in advance. In the latter case, processing can automatically proceed to S108 without an input operation by a measurer.

In S108, the positional information calculating unit 204 calculates a three-dimensional position of each measuring point configured by the measuring point configuring unit 203. Specifically, the measuring point configuring unit 203 calculates, based on the reference image corresponding to the measuring point whose three-dimensional position is to be calculated (reference image selected by the image selecting unit 202 in S104 immediately before configuration of the measuring point) and an image that is not selected (comparison image), a parallax value of the measuring point by the stereo method. The measuring point configuring unit 203 calculates the three-dimensional position based on a camera coordinate system of the imaging device capturing the initial reference image, based on the parallax value. Details of S108 will be described later.

Subsequently, the measuring value calculating unit 205 performs prescribed measuring processing by using three-dimensional positional information indicating the three-dimensional position about each measuring point calculated by the positional information calculating unit 204 in S108 (S109). The measuring value calculating unit 205 outputs a result of the above-described measuring processing (S110).

Note that an output destination of the result is not particularly limited and may be, for example, the display unit 30 or an external device of the measuring device 1. An output manner at an output destination is also not particularly limited. For example, the display unit 30 may display and output an image (the first image or the second image) on which a calculated measuring value is superimposed and displayed, whereas a calculated numerical value in text format may be output to the external device.

The prescribed measuring processing described above is not particularly limited as long as it is computing processing with three-dimensional positional information. For example, the measuring processing may be processing of calculating a distance from an imaging device to a subject, a length between measuring points, an area of a surface surrounded by multiple measuring points, or the like by using three-dimensional positional information. Information indicating a measuring value calculated by such processing is output in S110. Such information can be calculated by using a known technology from a relationship between points in a three-dimensional space. In this way, in the case that multiple measuring points are configured, a calculated measuring value may be an arbitrary measuring value that can be calculated from a relationship between multiple points in a three-dimensional space.

FIG. 7 is a diagram illustrating an example of displaying measuring values calculated by using three-dimensional positional information about the two measuring point positions P1, P2 illustrated in FIG. 5 and FIG. 6, respectively. In the example of FIG. 7, respective information pieces indicating a distance from an imaging device to a subject in the measuring point position P1, a distance from the imaging device to the subject in the measuring point position P2, and a length between the measuring point position P1 of the subject and the measuring point position P2 of the subject are superimposed and displayed on the first image being the initial reference image.

Note that the measuring point position P1 illustrated in FIG. 5 is positional information in the coordinate system of the second image, and thus a position of a corresponding point that can be calculated in S109 is superimposed and displayed as the measuring point position P1 on the first image in FIG. 7. The measuring device 1 calculates three-dimensional positions of the measuring points and performs prescribed measuring with the three-dimensional positional information indicating the three-dimensional positions by the processing procedure described above.

### Calculation of Three-Dimensional Positional Information in S108

Subsequently, contents of processing in S108 are described in detail. In S108, the positional information calculating unit 204 calculates three-dimensional position information of each measuring point configured before S108. First, for calculating the three-dimensional positional information, the positional information calculating unit 204 uses the reference image selected by the image selecting unit 202 in S104 and the other image (comparison image) to calculate a parallax value of both the images in the measuring point by the stereo method.

Subsequently, the positional information calculating unit 204 calculates three-dimensional positional information of the measuring point by substituting the calculated parallax value in following Equation (2).

$$X = \frac{( u - {u}_{c} ) \times B}{D} \\ Y = \frac{( v - {v}_{c} ) \times B}{D} \\ Z = \frac{f \times B}{p \times D} \qquad [ Equation 2 ]$$

Here, (u, v) is measuring point positional information in a two-dimensional coordinate system of the image used as the initial reference image in S101. (X, Y, Z) is three-dimensional positional information in a camera coordinate system of the imaging device capturing the image used as the initial reference image. (u_{c}, v_{c}) indicates coordinates of a main point on the initial reference image. B indicates a base line length between two imaging devices (between capturing positions), p indicates a pixel pitch of an image sensor included in the imaging device, and D indicates a parallax value.

Note that in a case that the image selected by the image selecting unit 202 in S104 is not the initial reference image (in a case that the image is the second image), the measuring point position configured by the measuring point configuring unit 203 in S106 is not a position in a two-dimensional coordinate system of the initial reference image. Thus, in this case, a position of a corresponding point on the comparison image (first image) obtained in the parallax calculation by the stereo matching is substituted in (u, v) of Equation (2) to calculate the three-dimensional positional information of the measuring point.

By the method described above, the positional information calculating unit 204 calculates the three-dimensional positional information of the measuring point as information based on the camera coordinate system of the imaging device capturing the initial reference image regardless of which image is selected by the image selecting unit 202 as the reference image in S104. Accordingly, the coordinate system of the configured measuring point is unified, and thus the measuring processing can be performed with three-dimensional positional information in S109 subsequent to S108. Note that a unified coordinate system in positional information of the measuring points enables a computation with three-dimensional positional information, so that a camera coordinate system of an imaging device capturing an image, which is not the initial reference image, may be used.

By the method described above, the measuring device 1 analyzes a state of a subject around a configured measuring point candidate position, uses an image in which no occlusion region is captured around the measuring point candidate position as a reference image, and configures a measuring point on the reference image. Thus, a possibility that a measuring point is configured in an occlusion region can be reduced. Accordingly, a measuring point having a high degree of reliability can be configured while accuracy of searching for a corresponding point is high, so that three-dimensional positional information about the measuring point can be accurately calculated. Furthermore, various measuring values including a distance to a measuring point and a length between measuring points can be calculated with high accuracy by using the three-dimensional positional information. No processing of estimating an occlusion region from the whole image is performed, so that measuring can be performed with a small amount of processing with exclusion of an occlusion region. In a case that a measurer inputs a measuring point candidate position and a measuring point position, the measurer himself/herself does not need to be aware of an occlusion region, thereby resulting in no burden on the measurer.

### Second Embodiment

A second embodiment of the present invention will be described below in detail. Note that a similar constitution to that of the embodiment above is denoted by the same reference numeral, and description thereof will be omitted.

### Measuring Device 2

A measuring device (calculating device) 2 according to the present embodiment has a similar constitution to that of the measuring device 1 in the first embodiment illustrated in FIG. 1, but differs from the measuring device 1 in that the measuring unit 20 is changed to a measuring unit 21. The measuring unit 21 includes a measuring range configuring unit 206 in addition to each block included in the measuring unit 21.

The measuring range configuring unit 206 configures a measuring point range based on a measuring point candidate position on a reference image. The measuring point range is a range in which the measuring point configuring unit 203 can configure a measuring point on a reference image. The addition of the measuring range configuring unit 206 can facilitate an input of a measuring point to an appropriate position on a reference image.

### Measuring Method: Flow of Processing

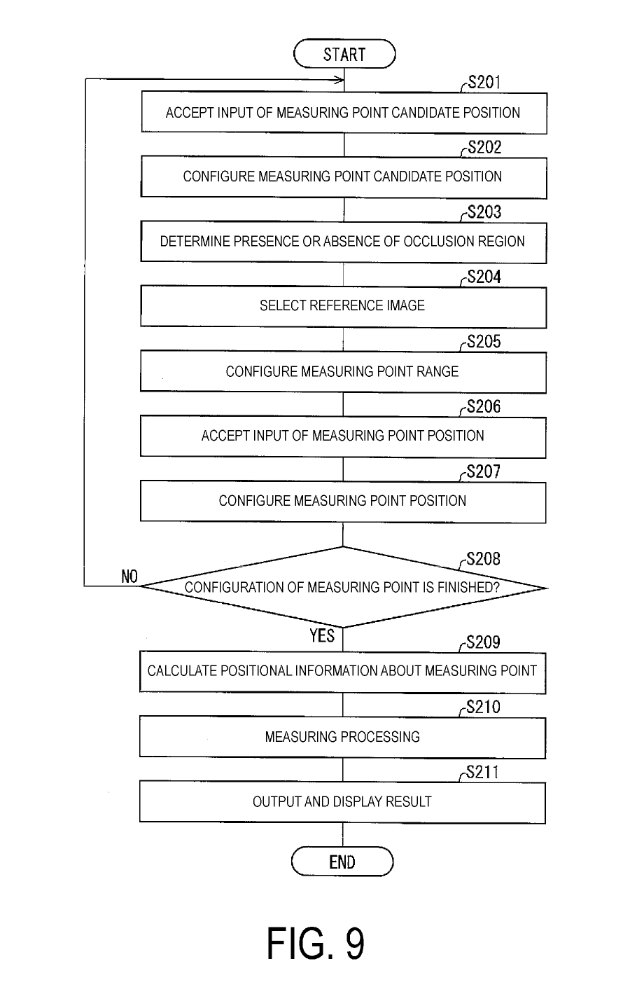

With reference to FIG. 9, a measuring method (a method for controlling a calculating device) by the measuring device 2 will be described below. FIG. 9 is a flowchart illustrating an example of processing performed by the measuring device 2. S201 to S204, S207 to S211 in the flowchart of FIG. 9 are respectively similar processing to S101 to S104, S106 to S110 in FIG. 2. In other words, the flowchart of FIG. 9 includes processing of S205 added after S104 in the flowchart of FIG. 2 and thus includes S206 changed from S105. Herein, S205 and S206, which are the differences between FIG. 2 and FIG. 9, are described, and the description of the other processing is omitted.

As in the measuring device 1 in the first embodiment, the measuring device 2 accepts an input of a measuring point candidate position to the first image being a left viewpoint image as an initial reference image, configures the measuring point candidate position, and determines whether there is an occlusion region around the measuring point candidate position (S201 to S203). Then, a reference image according to the result of S203 is selected (S204).

Here, the measuring range configuring unit 206 configures a measuring point range on the reference image selected by the image selecting unit 202 in S204 (S205). The measuring point range is a range in which a measuring point position can be configured by processing in a subsequent stage, and the measuring point range is configured based on a measuring point candidate position. How the measuring point range is configured in S205 will be described later.

Next, the measuring point configuring unit 203 accepts an input of a measuring point position in the measuring point range configured by the measuring range configuring unit 206 in S205 (S206). As described in the embodiment above, a manner in which an input of a measuring point position is accepted is not particularly limited. For example, a reference image may be displayed on the display unit 30 and a measurer may select a measuring point position from the reference image. In this case, only the measuring point range configured by the measuring range configuring unit 206 may be displayed, and this allows the measurer to recognize the measuring point range and also to reliably input a measuring point position within the range. In addition, information indicating the measuring point range (for example, a shape such as a circle and a rectangle indicating an outer edge of the measuring point range) may be superimposed and displayed on the reference image, and such a constitution also allows the measurer to recognize the measuring point range. Furthermore, an image of the measuring point range may be enlarged and displayed, and this allows the measurer to easily check contents of the image and to easily input an appropriate measuring point position. Also, in a case that a measuring point position is input from an external device, limiting a range capable of receiving an input of a measuring point from the measurer to the measuring point range can reduce a possibility that an incorrect position greatly displaced from the measuring point candidate position configured first by the measurer is configured as a measuring point.

Subsequently, the measuring point configuring unit 203 configures the measuring point in the position of the measuring point that has accepted the input (S207). Subsequent processing is similar to that in the first embodiment. Note that in a case that the reference image selected in S204 is the same as the initial reference image in the processing described above, S206 can be omitted, and S205 can also be omitted in a case that S206 is omitted.

### Configuration of Measuring Point Range in S205

Subsequently, contents of processing in S205 are described in detail. In S205, the measuring range configuring unit 206 configures a measuring point range on the reference image by using the measuring point candidate position. As described above, in S206 subsequent to S205, a measuring point position is accepted within the measuring point range configured in S205. In other words, the configuration of the measuring point range by the measuring range configuring unit 206 allows a measuring point to be configured in a more appropriate position with exclusion of a range greatly displaced from the measuring point candidate position.

The measuring range configuring unit 206 configures the measuring point range in a surrounding range with the measuring point candidate position as a center so as to include a desired measuring point position. The size (pixel size) of the measuring point range is, for example, configured as a fraction (e.g., 1/(several number)) of a pixel resolution in advance.

Here, the measuring point candidate position is a position in a coordinate system of the initial reference image. Thus, in a case that the presence of the occlusion region is determined in S203 and an image, which is not the initial reference image, is selected as the reference image in S204, the measuring point candidate position on the reference image is displaced in a parallax direction. For this reason, the measuring range configuring unit 206 may configure the measuring point range in a sufficiently wide range in the parallax direction with consideration given to the displacement in the case that the image, which is not the initial reference image, is selected as the reference image. For example, the measuring range configuring unit 206 may expand a range configured using the measuring point candidate position as a center by a prescribed length in the parallax direction, and may use the expanded range as the measuring point range. Note that the second image is the right viewpoint image in the present embodiment, so that the expanded parallax direction is a left direction.

The measuring range configuring unit 206 may substitute the base line length B between the imaging devices capturing the first image and the second image and the distance Z from the imaging device to the subject in Equation (1) described above to calculate a parallax value. Then, with the parallax value as the amount of displacement, a central position of the measuring point range may be displaced in advance to be configured.

Note that in a case that an imaging device is fixed (for example, in such a case that the same camera is moved to perform measurement), f and p of the variables included in Equation (1) remain unchanged, and only values of D, B, and Z change. In a case that a measured target is clear to some extent, a distance from which a subject is captured is also clear to some extent. Thus, an approximate parallax value D can be calculated on the assumption that such an approximate distance is Z mentioned above.

In this way, the measuring range configuring unit 206 can configure the measuring point range with the measuring point candidate as a center or around a center even in the case that the measuring point range is configured in the second image, which is not the initial reference image. With this constitution, an unnecessarily wide measuring point range can be thus avoided, so it is preferable. In a case where the amount of displacement in which a central position of a measuring point range is displaced to be configured can be changed by an input device such as the input unit 10, a measurer can input a measuring point while adjusting the measuring point range to an appropriate position.

In the measuring device 2 in the present embodiment, the measuring range configuring unit 206 configures a measuring point range on a reference image, based on a measuring point candidate position by the method described above. Then, the measuring point position is configured in the measuring point range. Thus, a possibility that measuring accuracy decreases due to configuration of a measuring point in an occlusion region can be reduced, and a measuring point can also be configured with higher accuracy with exclusion of a range greatly displaced from a measuring point candidate position. Furthermore, only the configured measuring point range may be enlarged and displayed. In this case, a measurer can easily check an image and easily input an appropriate measuring point position, so that the measuring point can be configured with high accuracy.

### Third Embodiment

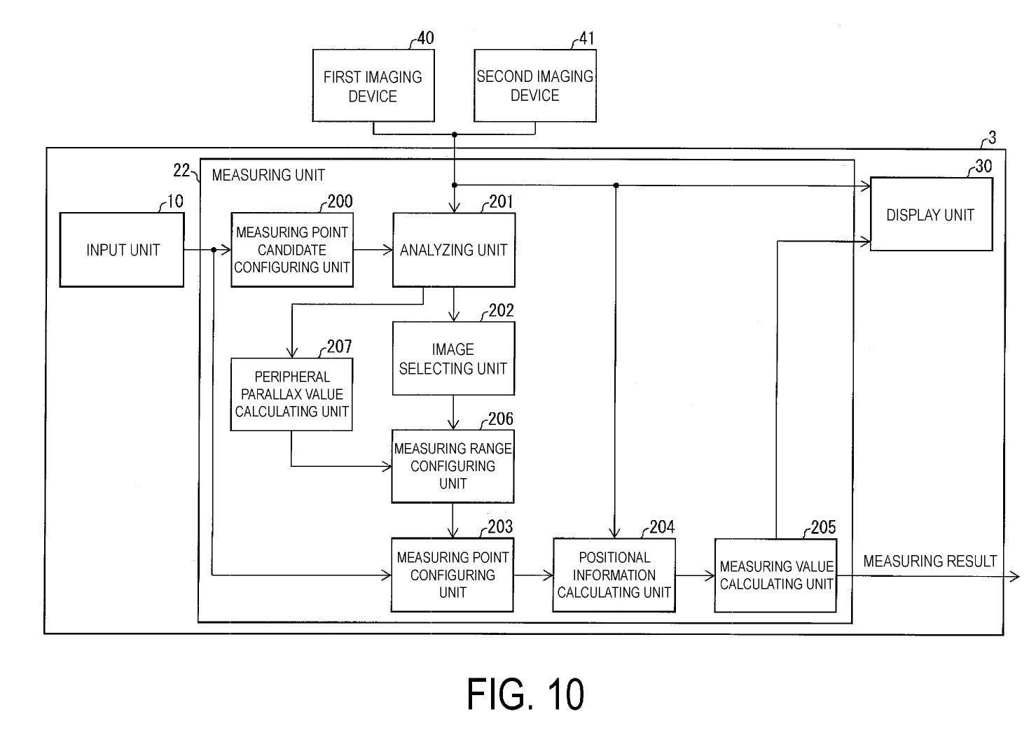

A third embodiment of the present invention will be described below in detail with reference to FIG. 10. Note that a similar constitution to that of the embodiment above is denoted by the same reference numeral, and description thereof will be omitted.

### Measuring Device 3

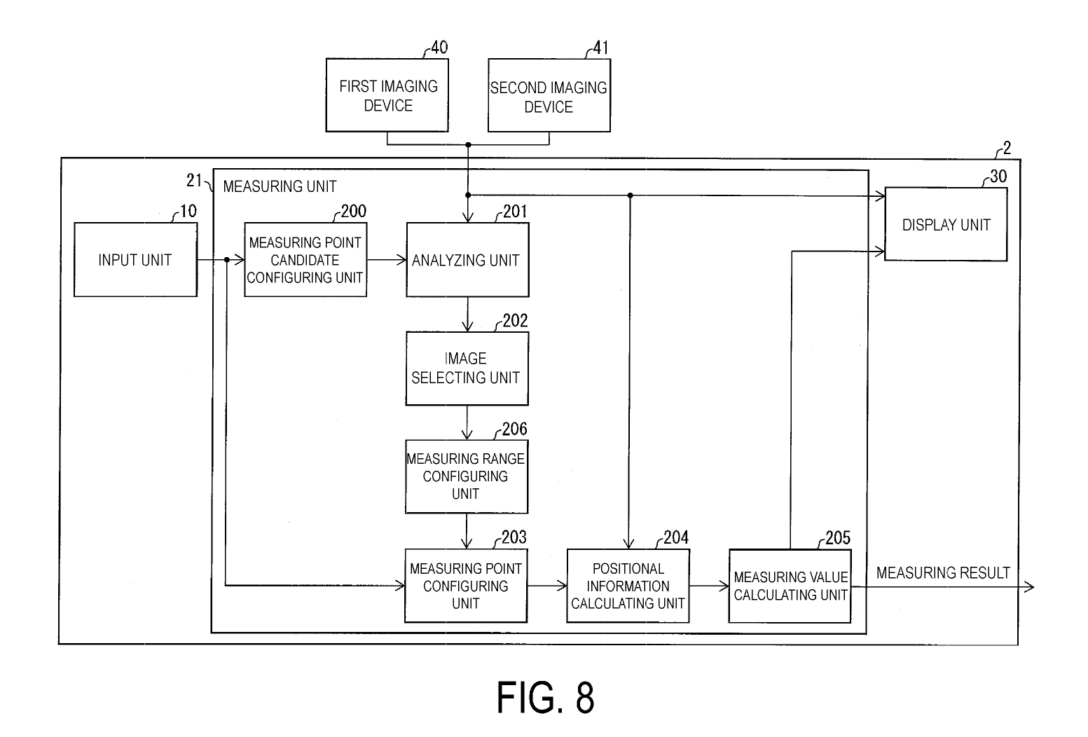

As illustrated in FIG. 10, a measuring device (calculating device) 3 according to the present embodiment has the similar constitution to that of the measuring device 2 in the second embodiment illustrated in FIG. 8, but differs from the measuring device 2 in that the measuring unit 21 is changed to a measuring unit 22. The measuring unit 22 includes a peripheral parallax value calculating unit 207 in addition to each block included in the measuring unit 21. The peripheral parallax value calculating unit 207 calculates the amount of displacement for correcting a central position of a measuring point range.

### Measuring Method

A measuring method performed by the measuring device 3 includes a processing procedure further added to the measuring method performed by the measuring device 2. In the measuring method performed by the measuring device 3, the measuring point range described above can be configured as a more preferable range.

Herein, in a case that the presence of an occlusion region around a measuring point candidate position is determined and an image, which is not the initial reference image, is selected as the reference image, displacement of the measuring point candidate position occurs. For example, in a case that the second image is used as the reference image after the measuring point candidate position is configured on the initial reference image (first image) as illustrated in FIG. 4, the measuring point candidate position K1 in FIG. 4 is in a position displaced to the inside of the subject A (on the right side with respect to the left edge) on the reference image (second image) in FIG. 5. Thus, in the second embodiment 2 described above, it is described that the measuring range configuring unit 206 may configure a wide measuring point range or configure a displaced central position.

In the measuring device 3 according to the present embodiment, the peripheral parallax value calculating unit 207 calculates a parallax value of pixels near a measuring point candidate position, and the measuring range configuring unit 206 corrects a position being a reference for configuring a measuring point range by using the parallax value as the amount of displacement of a central position of the measuring point range.

### Flow of Processing

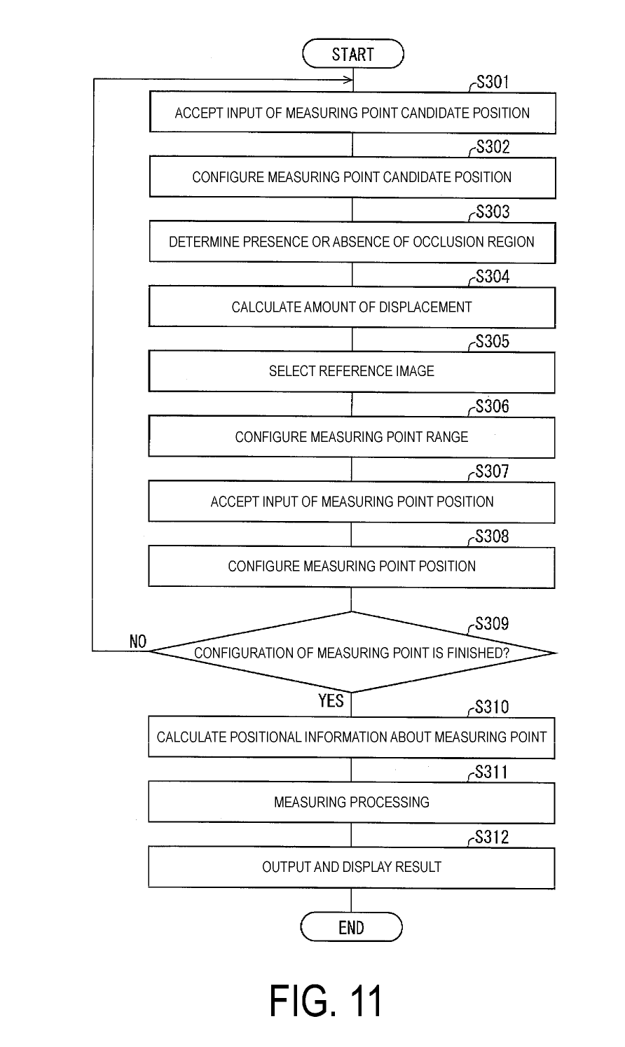

With reference to FIG. 11, a processing procedure of a measuring method (a method for controlling a calculating device) by the measuring device 3 will be described below. FIG. 11 is a flowchart illustrating an example of processing performed by the measuring device 3. S301 to S303, S305 to S312 in the flowchart of FIG. 11 are respectively similar processing to S201 to S203, S204 to S211 in FIG. 9. In other words, the flowchart of FIG. 11 includes processing of S304 added after S203 in the flowchart of FIG. 9. Here, S304, which is the difference between FIG. 9 and FIG. 11, is mainly described, and the description of the other processing is omitted.

As in the measuring device 1 in the first embodiment, the measuring device 3 accepts an input of a measuring point candidate position to the first image being a left viewpoint image as an initial reference image, configures the measuring point candidate position, and determines whether there is an occlusion region around the measuring point candidate position (S301 to S303).

Herein, in a case that the analyzing unit 201 determines that the occlusion region is included in a range of the prescribed number of pixels around the measuring point candidate position in S303, the peripheral parallax value calculating unit 207 calculates the amount of displacement for correcting a central position of a measuring point range (S304). Details of a method for calculating the amount of displacement in S304 will be described later. The image selecting unit 202 selects a reference image according to the analysis result in S303 by similar method to that in S104 described in the first embodiment (S305).

Next, the measuring range configuring unit 206 configures the measuring point range with a position displaced from the measuring point candidate position by the amount of displacement calculated in S304 as a center of the measuring point range (S306). Accordingly, an appropriate measuring point range adapted to the displacement of the measuring point candidate position due to the second image serving as the reference image is configured. The processing (S307 to S312) after the measuring point range is configured is similar to that in the embodiment 2.

Note that the measuring range configuring unit 206 may configure the size (pixel size) of the measuring point range based on the amount of displacement calculated by the peripheral parallax value calculating unit 207 in S304 at the time of configuring the measuring point range in the processing S306. The amount of displacement calculated in S304 is a parallax value of a subject located at the front of a captured subject located near the measuring point candidate position, which will be described later in detail. A distance from an imaging device to the subject can be calculated by using the parallax value, namely, the amount of displacement calculated in S304.

For this reason, the measuring range configuring unit 206 may change the size of the measuring point range according to the distance. For example, a distance to the subject increases and a smaller subject at a long distance is captured on an image with a smaller amount of displacement. Thus, the measuring range configuring unit 206 may configure a narrower (smaller) measuring point range with a smaller amount of displacement. On the contrary, a distance to the subject decreases and a greater subject at a short distance is captured on an image with a greater amount of displacement. Thus, the measuring range configuring unit 206 may configure a wider (greater) measuring point range with a greater amount of displacement. An appropriate range according to a distance to a subject near a measuring point candidate position can be configured as a measuring point range by such a method. A method for configuring a measuring point range having an area according to the amount of displacement is not particularly limited. For example, a measuring point range having a different area according to the amount of displacement can be configured by configuring a range of the amount of displacement (parallax value) and an area of each range according to the amount of displacement in advance.

### Calculation of Amount of Displacement in S304

Subsequently, processing contents of the processing S304 are described in detail. In the case that the analyzing unit 201 determines that there is the occlusion region in S303 in the previous stage, the peripheral parallax value calculating unit 207 calculates the amount of displacement for correcting a central position of the measuring point range in S304.

Here, a corresponding point on one image of the first image and the second image corresponding to a position of a focused point on the other image is in a position displaced by parallax from the position of the focused point, and a parallax value of the focused point is the amount of displacement of the position. Therefore, the amount of displacement can be obtained by calculating a parallax value of the measuring point candidate position, and the measuring point range can be configured in an appropriate position with the position displaced by the amount of displacement as a central position of the measuring point range.

However, in a case that the measuring point candidate position is in the occlusion region, displacement occurs in configuration of the measuring point range and the central position of the measuring point range needs to be corrected. Thus, in such a situation, it is difficult to calculate a correct parallax value of the measuring point candidate position as described above. For this reason, in the case that the measuring point candidate position is in the occlusion region, the peripheral parallax value calculating unit 207 calculates a parallax value of a position, which is not in the occlusion region, around the measuring point candidate position and uses the parallax value as the amount of displacement in S304.

Here, the occlusion region occurs in a position in which two subjects (the subject A and the background B in the case of FIG. 3) at different distances from an imaging device overlap each other, and occurs, like the occlusion region O1 in FIG. 3, in a left region of a subject (the subject A) at the front on a left viewpoint image. Therefore, in a case that the analyzing unit 201 determines that the measuring point candidate position configured on the left viewpoint image is in the occlusion region, it can be determined that there is a subject at the front on the right side of the measuring point candidate position.

For this reason, the analyzing unit 201 calculates a degree of similarity between pixels while displacing a position in turn in a right direction of the measuring point candidate position, and obtains a position having a high degree of similarity, namely, a position, which is not in the occlusion region. The degree of similarity can be calculated by the method described in the first embodiment. The peripheral parallax value calculating unit 207 calculates a parallax value of a position, which is not in the occlusion region determined first by the analyzing unit 201, and uses the value as the amount of displacement. Note that a parallax value can be calculated by the stereo method as described in the first embodiment.

On the contrary to the case above, in a case that the measuring point candidate configuring unit 200 configures a measuring point candidate position on a right viewpoint image, a positional relationship between a subject and an occlusion region is also reversed. Thus, in this case, a direction in which pixels are scanned for calculating a degree of similarity is changed from the right direction to the left direction, and the similar processing is performed.

In the measuring device 3 in the present embodiment, the peripheral parallax value calculating unit 207 calculates a parallax value of a position, which is not in an occlusion region, near (around) a measuring point candidate position as the amount of displacement for correcting a position of a measuring point range by the method described above. Thus, the measuring point range can be configured in an appropriate position. A measurer can input a measuring point within this measuring point range, and thus a possibility that measuring accuracy of three-dimensional positional information decreases due to configuration of a measuring point in an occlusion region can be further reduced.

An appropriate range according to a distance from an imaging device to a subject near a measuring point candidate position can be configured as a measuring point range by the above-described method for changing a pixel range of the measuring point range, based on a parallax value. Therefore, a more appropriate measuring point range can be configured. This allows a more appropriate measuring point position to be configured and allows measuring regarding the measuring point position to be performed.

### Modifications

It is assumed that the two input images are captured by the stereo cameras disposed on the horizontal plane in the measuring device described in each of the embodiments above, but this is not restrictive. For example, even in a case that two imaging devices are disposed in a vertical direction, the measuring method described in each of the embodiments above is similarly applicable. In the case that the stereo cameras are disposed on the vertical axis, a direction of parallax is on the vertical axis, so that a scanning axis during parallax calculation is also the vertical axis. Multiple images at different capturing positions that are captured by one imaging device moving in a direction parallel to a subject may be used instead of using multiple images captured by multiple different imaging devices.

Each of the embodiments above exemplifies measuring with two images, but measuring with three or more images is also possible as long as the images are captured from different positions so as to include at least a part of a common region.

Furthermore, each of the embodiments above exemplifies that a measurer specifies a measuring point position on a reference image, but a measuring point position may be automatically configured. In the case that a measuring point position is automatically configured, a position of a corresponding point to a measuring point candidate position, a position of a central point in the measuring point range described above, or an arbitrary position in the measuring point range, for example, may be used as a measuring point position. A position automatically obtained in such a manner may be displayed as a candidate for a measuring point position, and a measurer may be caused to select whether the candidate is used as the measuring point position or which candidate is the measuring point position.

### Implementation Examples by Software

The control block (measuring units 20, 21, and 22 in particular) of the measuring device (measuring devices 1, 2, and 3) may be implemented by a logic circuit (hardware) formed on an Integrated Circuit (IC chip) or the like, or by software using a CPU. In the former case, it may be implemented by a programmable integrated circuit such as a Field Programmable Gate Array (FPGA). In the latter case, the measuring device includes the CPU performing instructions of a program that is the software implementing the functions, a Read Only Memory (ROM) or a storage device (collectively referred to as a “recording medium”) in which the above-described program and various pieces of data readable by a computer (or CPU) are recorded, a RAM developing the above-described program, or the like. The computer (or CPU) reads from the recording medium and performs the program to achieve the object of one aspect of the present invention. As the above-described recording medium, a “non-transitory tangible medium” such as a tape, a disk, a card, a semiconductor memory, and a programmable logic circuit can be used. The above-described program may be supplied to the above-described computer via an arbitrary transmission medium (such as a communication network and a broadcast wave) capable of transmitting the program. Note that one aspect of the present invention may also be implemented in a form of a data signal embedded in a carrier wave in which the program is embodied by electronic transmission.

### Supplement

A calculating device (measuring devices 1 to 3) according to Aspect 1 of the present invention is a calculating device configured to calculate, by using multiple images (first image, second image) capturing a subject that is a common subject, a three-dimensional position of a measuring point configured on the subject. The calculating device includes: an analyzing unit (201) configured to analyze the multiple images and to determine whether there is an occlusion region in at least any of a measuring point candidate position configured by a user of the calculating device on an initial reference image as a candidate for a configured position of the measuring point, the initial reference image being one of the multiple images, and a position in a prescribed range from the measuring point candidate position; an image selecting unit (202) configured to select an image of the multiple images other than the initial reference image as a reference image in a case that the analyzing unit determines that there is an occlusion region; and a measuring point configuring unit (203) configured to configure the measuring point on the reference image.

According to the constitution above, in a case that it is determined that there is an occlusion region in at least any of a measuring point candidate position configured by a user and a position within a prescribed range from the measuring point candidate position, an image other than the initial reference image is used as the reference image and a measuring point is configured on the reference image. Thus, a decrease in calculating accuracy due to configuration of a measuring point in or around an occlusion region can be prevented.

Furthermore, according to the constitution above, whether there is an occlusion region may be determined from at least any of a measuring point candidate position and a position within a prescribed range from the measuring point candidate position. Thus, the amount of computing processing does not excessively increase in comparison with a case of estimating whether any region of the whole image is an occlusion region.

Note that a position of the measuring point configured on the reference image may be selected by a user or automatically decided. Even in the former case, the user can configure the measuring point in a desired position on the reference image similarly to configuration of a measuring point candidate position on the initial reference image without being aware of an occlusion region. Thus, a decrease in calculating accuracy can be prevented without increasing a burden on the user.

A calculating result output from the calculating device may be a calculated three-dimensional position or the other measuring value calculated with the three-dimensional position. The other measuring value can be a measuring value that can be calculated with a three-dimensional position and includes, for example, a distance from an imaging device to a measuring point on a subject or the like. For calculation of the other measuring value, a parameter such as a capturing position, a focal distance, a pixel pitch of an image sensor may be used in addition to the calculated three-dimensional position.

The measuring device (2) according to Aspect 2 of the present invention in Aspect 1 above may further include a measuring range configuring unit (206) configured to configure a measuring point range on the reference image based on the measuring point candidate position. The measuring point configuring unit may be configured to configure the measuring point in a position within the measuring point range that is configured.

According to the configuration above, a measuring point range is configured based on a measuring point candidate position configured by a user on a reference image, and a measuring point is configured in a position in the measuring point range. Thus, the measuring point can be configured in the range according to the measuring point candidate position configured by the user. For example, this can configure a measuring point in a position greatly away from a measuring point candidate position on a subject and can also prevent a measuring point from being configured on the other subject different from a subject on which a measuring point candidate position is configured.

The measuring device (3) according to an Aspect 3 of the present invention in the Aspect 2 above further includes a peripheral parallax value calculating unit (207) configured to calculate a parallax value between a position, which is not in the occlusion region, around the measuring point candidate position and a corresponding position corresponding to the position on an image of the multiple images other than the initial reference image. The measuring range configuring unit may be configured to configure the measuring point range based on a position obtained by correcting the measuring point candidate position according to the parallax value.

Here, in a case that the initial reference image and the reference image are the images captured from positions displaced in a direction parallel to a subject, a position corresponding to the measuring point candidate position on the reference image is in a position displaced from the measuring point candidate position by parallax in a parallax direction. Thus, according to the constitution above that configures the measuring point range based on a position obtained by correcting the measuring point candidate position according to the parallax value, an appropriate measuring point range can be configured by eliminating an influence of the amount of displacement. Note that the appropriate measuring point range is a range configured based on a position on the reference image capturing the same portion as the measuring point candidate position.

In the measuring device (3) according to Aspect 4 of the present invention in Aspect 3, the measuring range configuring unit (206) may be configured to configure an area of the measuring point range according to a magnitude of the parallax value.

Here, in a case that a common subject is captured from multiple positions, a parallax value between images obtained from different capturing positions is inversely proportional to a distance from an imaging device (image-capturing position) to a subject. In other words, a distance from an imaging device to a subject decreases with a greater parallax value. With the short distance from the imaging device to the subject, a range of the captured image covered by the subject is relatively great.

Thus, according to the constitution above that configures an area of the measuring point range according to a magnitude of the parallax value, a user can easily configure a desired measuring position from the image in which the subject covers a great range. More specifically, a greater measuring point range may be configured with a greater parallax value, namely, a smaller distance from an imaging device (capturing position) to a subject. Alternatively, a narrower measuring point range may be configured with a smaller parallax value, namely, a longer distance from an imaging device to a subject.

A method for controlling a calculating device (measuring devices 1 to 3) according to Aspect 5 of the present invention is a method for controlling a calculating device configured to calculate, by using multiple images capturing a subject that is a common subject, a three-dimensional position of a measuring point configured on the subject. The method includes the steps of: analyzing the multiple images and determining whether there is an occlusion region in at least any of a measuring point candidate position configured by a user of the calculating device on an initial reference image as a candidate for a configured position of the measuring point, the initial reference image being one of the multiple images, and a position in a prescribed range from the measuring point candidate position; selecting an image of the multiple images other than the initial reference image as a reference image in a case that it is determined that there is an occlusion region in the step of analyzing the multiple images; and configuring the measuring point on the reference image. According to this constitution, the same effect as that of Aspect 1 can be achieved.

The calculating device according to each of the aspects of the present invention may be implemented by a computer. In this case, a control program of the calculating device configured to cause a computer to operate as each unit (software component) included in the calculating device to implement the calculating device by the computer and a computer-readable recording medium configured to record the control program are also included in the scope of the present invention.

The embodiment of the present invention is not limited to each of the above-described embodiments. It is possible to make various modifications within the scope of the claims. Embodiments obtained by appropriately combining technical elements disclosed in different embodiments falls also within the technical scope of the present invention. Further, when technical elements disclosed in the respective embodiments are combined, it is possible to form a new technical feature.

This application claims priority based on JP 2015-177719 filed in Japan on Sep. 9, 2015, the contents of which are incorporated herein by reference.

### REFERENCE SIGNS LIST

1 to 3 Measuring device (Calculating device)
201 Analyzing unit
202 Image selecting unit
203 Measuring point configuring unit
206 Measuring range configuring unit
207 Peripheral parallax value calculating unit

1.-5. (canceled)

6. A calculating device configured to calculate, by using multiple images capturing a subject, a measuring value of a measuring point on the subject, the calculating device comprising:
displaying circuitry configured to display an initial reference image that is one of the multiple images, and display an image of the multiple images other than the initial reference image as a reference image in a case that there is an occlusion region in at least one of (i) a measuring point candidate position configured on the initial reference image as a candidate for a configured position of the measuring point and (ii) a position in a prescribed range from the measuring point candidate position; and
measuring point configuring circuitry configured to configure the measuring point on the reference image.

7. The calculating device according to claim 6, wherein the measuring point configuring circuitry is configured to configure the measuring point in a position within a measuring point range that is configured on the reference image based on the measuring point candidate position.

8. The calculating device according to claim 7, wherein the measuring point configuring circuitry is configured to configure the measuring point range based on a position obtained by correcting the measuring point candidate position according to a parallax value between a position, which is not in the occlusion region, around the measuring point candidate position and a corresponding position corresponding to the position on an image of the multiple images other than the initial reference image.

9. The calculating device according to claim 8,
wherein the measuring point configuring circuitry is configured to configure an area of the measuring point range according to a magnitude of the parallax value.

10. A method for controlling a calculating device configured to calculate, by using multiple images capturing a subject, a measuring value of a measuring point on the subject, the method comprising:
a reference image displaying step comprising displaying an initial reference image that is one of the multiple images, and displaying an image of the multiple images other than the initial reference image as a reference image in a case that there is an occlusion region in at least one of (i) a measuring point candidate position configured on the initial reference image that is one of the multiple images as a candidate for a configured position of the measuring point and (ii) a position in a prescribed range from the measuring point candidate position; and
a measuring point configuring step comprising configuring the measuring point on the reference image.

11. A computer-readable non-transitory recording medium in which a program causing a computer to function as the calculating device according to claim 6 is recorded.
